(19) United States
(12) Patent Application Publication
(10) Pub. No.: US 2009/0295727 A1
(43) Pub. Date: Dec. 3, 2009

(54) CONFIGURABLE APPARATUS FOR DIRECTIONAL OPERATION AND COMPUTER SYSTEM

(75) Inventors: Wen-Chieh Tseng, Taipei (TW); Yi-Hsuan Cheng, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ASUSTeK COMPUTER INC., Taipei (TW)

(21) Appl. No.: 12/414,675

(22) Filed: Mar. 31, 2009

(30) Foreign Application Priority Data
Jun. 2, 2008 (TW) 97120456

(51) Int. Cl. G06F 3/033; G06F 3/041

(52) U.S. Cl. 345/163; 345/173

(57) ABSTRACT

A configurable apparatus for directional operation and a computer system are provided. The configurable apparatus for directional operation includes a touch screen for detecting a touch signal, and an operation interface construction module. The operation interface construction module is provided for displaying a configurable interface of directional operation on the touch screen. The configurable interface of directional operation is thus adapted for change the displaying position, the displaying direction, or the layout thereof according to different application demands, so as to provide the user an operation method for ascertaining the convenience of operation and portability of the mobile electronic apparatus at the same time.

### CROSS-REFERENCE TO RELATED APPLICATION

This application claims the priority benefit of Taiwan application serial no. 97120456, filed Jun. 2, 2008. The entirety of the above-mentioned patent application is hereby incorporated by reference herein and made a part of specification.

### BACKGROUND OF THE INVENTION

1. Field of the Invention

The present invention generally relates to an apparatus for directional operation and an operation interface, and more particularly, to a configurable apparatus for directional operation, and a computer system including a program of a configurable interface of directional operation.

2. Description of Related Art

An input tool, such as a stylus or a finger is often used by a user when operating a mobile electronic apparatus equipped with a touch screen. Typically, the user has to use one hand to control the input tool, and use the rest hand to hold the mobile electronic apparatus. However, such a mobile electronic apparatus held by only one hand is often held with insufficient stability. Further, after holding the mobile electronic apparatus with only one hand for a long time, the user may feel tired and like to find another supporter to put the mobile electronic apparatus thereupon for relieving hand fatigue. This unfortunately impairs the portability of the mobile electronic apparatus.

Taking a popular tablet personal computer (PC) as an example, a cursor control point, and physical keys for correspondingly executing a left key function and a right key function of a mouse are often additionally disposed at an outside frame of a screen. When a user rotates a keyboard to accommodate the keyboard under the screen, the user is allowed to control the cursor's position via the cursor control point, and executing the left key function and the right key function of the mouse via the physical keys. However, both of the cursor control point and the physical keys are fixed at two sides of the outside frame of the screen. In other words, when the user desires to turn the screen for 90 degree from the custom operation position for operation, the positions of the cursor control point and the physical keys become inconvenient for the user to operate.

### SUMMARY OF THE INVENTION

Accordingly, the present invention is directed to provide a configurable apparatus for directional operation. The configurable apparatus for directional operation is adapted for displaying a configurable interface of directional operation on a touch screen. In such a way, a user is allowed to hold the mobile electronic apparatus by both hands and execute the directional operation at the same time, thus achieving better operational convenience.

The present invention is further directed to a computer system, storing a program for displaying a configurable interface of directional operation on a touch screen. The configurable interface is adapted for freely change a displaying position, a displaying direction, and a layout thereof as desired by the user, so that the user can operate the computer system with more flexibility, and feel more comfortable when operating.

For achieving the foregoing objects and others, the present invention provides a configurable apparatus for directional operation. The configurable apparatus for directional operation includes a touch screen for detecting a touch signal, and an operation interface construction module. The operation interface construction module is connected with the touch screen, for displaying a configurable interface of directional operation on the touch screen. The configurable interface of directional operation includes a mouse-key area and a cursor position controlling area. The operation interface construction module includes a mouse-key function driving module and a cursor position controlling module. The mouse-key function driving module is adapted for triggering a mouse-key function when the touch signal is determined as positioned within the mouse-key area. The cursor position controlling module is adapted for moving a cursor displayed on the touch screen according to a displacement of the touch signal in the cursor position controlling area when the touch signal is determined as positioned within the cursor position controlling area.

According to an embodiment of the present invention, the mouse-key area and the cursor position controlling area are displayed neighboring to each other on the touch screen. The operation interface construction module is adapted for displaying the configurable interface of directional operation at a position adjacent to a border of the touch screen. The border is a left border or a right border of the touch screen.

According to an embodiment of the present invention, the mouse-key area and the cursor position controlling area are displayed apart from each other on the touch screen. The operation interface construction module is adapted for displaying the mouse-key area and the cursor position controlling area at positions respectively adjacent to two individual borders of the touch screen. The two individual borders are a left border and a right border of the touch screen.

According to an embodiment of the present invention, the operation interface construction module further includes a displaying position adjusting module for defining a displaying position adjusting area in the configurable interface of directional operation, and moving the configurable interface of directional operation on the touch screen according to a displacement of the touch signal when the touch signal is determined as positioned within the displaying position adjusting area.

According to an embodiment of the present invention, the operation interface construction module further includes an interface rotation controlling module for defining an interface rotation controlling area in the configurable interface of directional operation, and switching a displaying direction of the configurable interface of directional operation when the touch signal is determined as positioned within the interface rotation controlling area. The displaying direction is defined as parallel with a direction of a view angle of the user.

According to an embodiment of the present invention, the operation interface construction module further includes a common hand setting module for defining a common hand setting area in the configurable interface of directional operation, and exchanging displaying positions of the mouse-key area and the cursor position controlling area when the touch signal is determined as positioned within the common hand setting area.

According to an embodiment of the present invention, the mouse-key function driving module is adapted for defining a left key area and a right key area in the mouse-key area, and for triggering a mouse-key function corresponding to a left key of a mouse when the touch signal is determined as positioned within the left key area and triggering a mouse-key function corresponding to a right key of the mouse when the touch signal is determined as positioned within the right key area.

According to an embodiment of the present invention, the operation interface construction module is adapted for displaying the configurable interface of directional operation on the touch screen according to a transparency. Further, when the touch screen does not receive any touch signal, the operation interface construction module displays the configurable interface of directional operation on the touch screen with the higher transparency.

Viewing from another point, the present invention further provides a computer system for storing a computer program including a plurality of program codes. The computer program is adapted to be loaded in a mobile electronic apparatus having a touch screen for displaying a configurable interface of directional operation on a touch screen. The configurable interface of directional operation includes a mouse-key area and a cursor position controlling area. The mouse-key area is adapted for triggering a mouse-key function, and the cursor position controlling area is adapted for controlling a position of a cursor displayed on the touch screen.

According to an embodiment of the present invention, the mouse-key area and the cursor position controlling area are displayed neighboring to each other on the touch screen. The configurable interface of directional operation is displayed at a position adjacent to a border of the touch screen. The border is a left border or a right border of the touch screen.

According to an embodiment of the present invention, the mouse-key area and the cursor position controlling area are separately displayed from each other on the touch screen. The mouse-key area and the cursor position controlling area are displayed at positions respectively adjacent to two individual borders of the touch screen. The two individual borders are a left border and a right border of the touch screen.

According to an embodiment of the present invention, the configurable interface of directional operation further includes a displaying position adjusting area, for adjusting a displaying position of the configurable interface of directional operation on the touch screen.

According to an embodiment of the present invention, the configurable interface of directional operation further includes an interface rotation controlling area for switching a displaying direction of the configurable interface of directional operation. The displaying direction is defined as parallel with a direction of a view angle of the user.

According to an embodiment of the present invention, the configurable interface of directional operation further includes a common hand setting area, for exchanging displaying positions of the mouse-key area and the cursor position controlling area.

According to an embodiment of the present invention, the mouse-key area further includes a left key area and a right key area. The left key area is adapted for triggering a mouse-key function corresponding to a left key of a mouse, and the right key area is adapted for triggering a mouse-key function corresponding to a right key of the mouse.

According to an embodiment of the present invention, the configurable interface of directional operation is displayed on the touch screen according to a transparency. Further, when the touch screen does not receive any touch signal, the configurable interface of directional operation is displayed on the touch screen with the higher transparency.

The present invention displays a configurable interface of directional operation allowing a user to freely change the displaying position, displaying direction, and layout of the interface. In such a way, the present invention not only is adapted for being rotated corresponding to a variation of a direction of using a mobile electronic apparatus, but also allows the user to execute a directional operation when holding the mobile electronic apparatus with both hands. As a result, the mobile electronic apparatus achieves the convenience of operation and an optimal portability at the same time.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram illustrating a configurable apparatus for directional operation according to an embodiment of the present invention.

FIG. 2 is a schematic diagram illustrating a configurable interface of directional operation according to an embodiment of the present invention.

FIGS. 3A, 3B, 3C and 3D are schematic diagrams illustrating a mobile electronic apparatus according to an embodiment of the present invention.

FIG. 4 is a schematic diagram illustrating a configurable interface of directional operation according to another embodiment of the present invention.

FIGS. 5A and 5B are schematic diagrams illustrating a mobile electronic apparatus according to another embodiment of the present invention.

### DESCRIPTION OF THE EMBODIMENTS

Reference will now be made in detail to the present preferred embodiments of the invention, examples of which are illustrated in the accompanying drawings. Wherever possible, the same reference counting numbers are used in the drawings and the description to refer to the same or like parts.

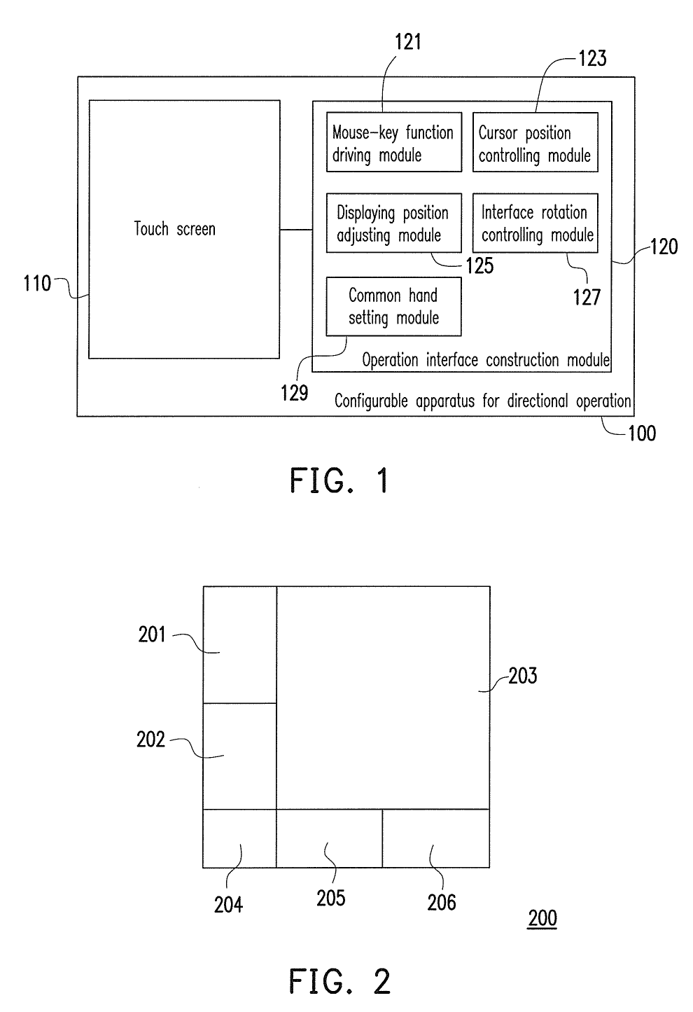

FIG. 1 is a block diagram illustrating a configurable apparatus for directional operation according to an embodiment of the present invention. Referring to FIG. 1, it shows a configurable apparatus for directional operation 100 including a touch screen 110, and an operation interface construction module 120. The touch screen 110 is adapted for displaying execution frames of application programs. The touch screen 110 is further adapted for receiving a touch signal generated by a user touching thereupon. The operation interface construction module 120 is connected with the touch screen 110 for displaying a configurable interface of directional operation on the touch screen 110. In an embodiment of the present invention, the configurable interface of directional operation includes a mouse-key area and a cursor position controlling area. The mouse-key area and the cursor position controlling area are displayed neighboring to each other. The operation interface construction module 120 is preferred to but not restricted to display the configurable interface of directional operation at a position adjacent to a border of the touch screen 110. The border is preferred to be but not restricted to be a left border or a right border.

For convenience of illustration, it is assumed that the configurable interface of directional operation is as shown in FIG. 2. FIG. 2 is a schematic diagram illustrating a configurable interface of directional operation according to an embodiment of the present invention. Referring to FIG. 2, it shows a configurable interface of directional operation 200. The configurable interface of directional operation 200 includes a mouse-key area constituted by a right key area 201 and a left key area 202, a cursor position controlling area 203, a displaying position adjusting area 204, an interface rotation controlling area 205, and a common hand setting area 206. It should be specified that the configurable interface of directional operation 200 and the arrangement of the foregoing areas are given for illustration purpose without restricting the spirit of the present invention and without limiting the scope of the present invention.

As shown in FIG. 1, the operation interface construction module 120 includes a mouse-key function driving module 121, a cursor position controlling module 123, a displaying position adjusting module 125, an interface rotation controlling module 127, and a common hand setting module 129. Referring to FIGS. 1 and 2 together, the aforementioned modules of the operation interface construction module 120 are to be depicted one by one in more details in accordance with the configurable interface of directional operation 200.

The mouse-key function driving module 121 is adapted for triggering a mouse-key function when the touch signal is determined as positioned within the mouse-key area of the configurable interface of directional operation 200. Specifically, when the mouse-key function driving module 121 determines that the touch signal is positioned within the left key area 202, the mouse-key function driving module 121 triggers a mouse-key function corresponding to a left key of a mouse; and when the mouse-key function driving module 121 determines that the touch signal is positioned within the right key area 201, the mouse-key function driving module 121 triggers a mouse-key function corresponding to a right key of the mouse.

The cursor position controlling module 123 is adapted for moving a cursor displayed on the touch screen 110 according to a displacement of the touch signal in the cursor position controlling area 203 when the touch signal is determined as positioned within the cursor position controlling area 203. In such a way, the user is allowed to execute functions of left key and right key of a mouse, and move the cursor displayed on the touch screen 110, by using his/her finger to touch the right key area 201, the left key area 202, and the cursor position controlling area 203 of the configurable interface of directional operation 200, respectively.

The displaying position adjusting module 125 is adapted for defining the displaying position adjusting area 204 in the configurable interface of directional operation 200. When the displaying position adjusting module 125 determines that the touch signal is positioned within the displaying position adjusting area 204, the displaying position adjusting module 125 moves the configurable interface of directional operation 200 on the touch screen 110 according to a displacement of a touch point. In other words, the user is allowed to execute a sliding operation to the configurable interface of directional operation 200 by touching the displaying position controlling area 204, so as to drag the configurable interface of directional operation 200 to a position desired by the user.

The interface rotation controlling module 127 is adapted for defining the interface rotation controlling area 205 in the configurable interface of directional operation 200. When the interface rotation controlling module 127 determines that the touch signal is positioned within the interface rotation controlling area 205, the interface rotation controlling module 127 switches a displaying direction of the configurable interface of directional operation 200. For example, the interface rotation controlling module 127 switches the displaying direction of the configurable interface of directional operation 200 to parallel with a direction of a view angle of the user, so as to facilitate the user views and operates the configurable interface of directional operation 200 more conveniently.

In the current embodiment, the operation interface construction module 120 further includes a common hand setting module 129. The common hand setting module 129 is adapted for defining the common hand setting area 206 in the configurable interface of directional operation 200. When the common hand setting module 129 determines that the touch signal is positioned within the common hand setting area 206, the common hand setting module 129 exchanges displaying positions of the mouse-key area (including right key area 201 and left key area 201) and the cursor position controlling area 203. Specifically, when the user touches the common hand setting area 206, the common hand setting module 129 then changes cursor position controlling area 203 from being displayed at a right side of the mouse-key area as original to being displayed at a left side of the mouse-key area 203. In other words, when the common hand setting module 129 determines that the touch signal is positioned within the common hand setting area 206, the common hand setting module 129 exchanges displaying positions of the mouse-key area and the cursor position controlling area 203. In such a way, regardless the user being left handed or right handed, he/she is allowed to conveniently set an operation mode as desired via the common hand setting area 206.

It should be noted that the operation interface construction module 120 displays the configurable interface of directional operation 200 on the touch screen 110 according to a transparency, so as to avoid the configurable interface of directional operation 200 displayed on the touch screen 110 from sheltering instant images originally displayed on the touch screen 110. In another embodiment of the present invention, if the touch screen 110 does not receive any touch signal, it represents that the user does not want to execute any operation via the configurable interface of directional operation 200 at present. In this case, the operation interface construction module 120 is going to display the configurable interface of directional operation 200 on the touch screen 110 with a transparency higher than when the touch screen 110 receives a touch signal, so as to allow the user to more clearly view the image content displayed on the touch screen 110.

According to the foregoing embodiments, the configurable apparatus for directional operation 100 can be equipped to a mobile electronic apparatus, such as a tablet PC, or an ultra mobile PC (UMPC), so as to display the configurable interface of directional operation 200 on the touch screen 110. In such a way, the present invention allows the user to hold the mobile electronic apparatus with both of his/her hands, and at the same time operate the configurable interface of directional operation 200 with his/her thumbs. As such, the present invention prevents fatigue caused by holding the mobile electronic apparatus with a single hand, and improves the operation convenience.

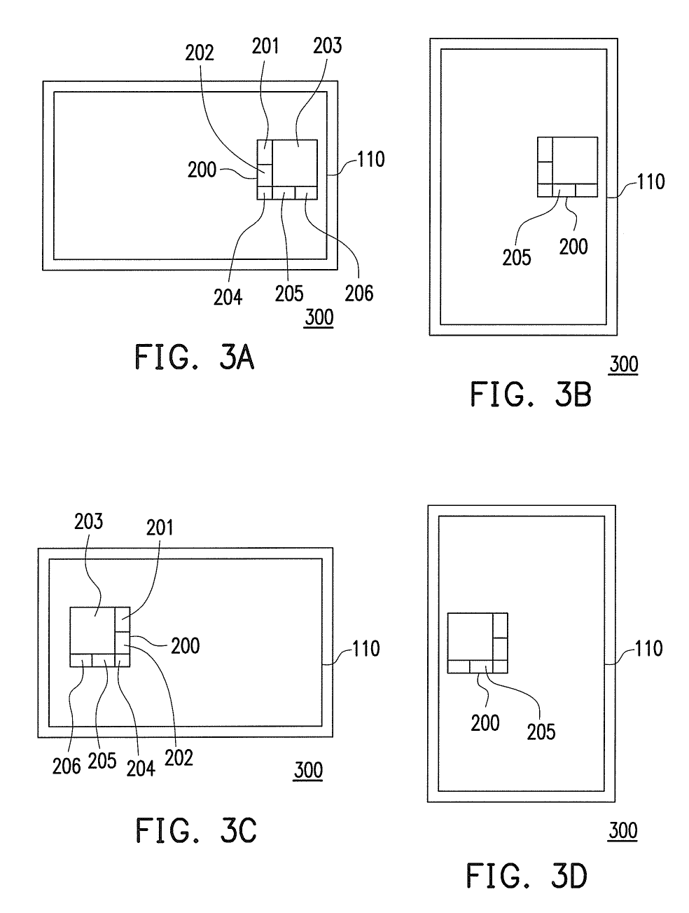

FIGS. 3A, 3B, 3C and 3D are schematic diagrams illustrating a mobile electronic apparatus according to an embodiment of the present invention. As shown in FIG. 3A, it depicts a mobile electronic apparatus 300, in which the configurable interface of directional operation 200 can be seen on the touch screen 110 by operating the configurable apparatus for directional operation 100. As such, when operating such a mobile electronic apparatus 300, a right handed user can conveniently hold the two sides (i.e., left side and right side) of the mobile electronic apparatus 300 by both hands, and move the cursor or execute the mouse-key function by the configurable interface of directional operation 200 displayed at a position adjacent to a right border of the touch screen 110. However, as shown in FIG. 3B, when the user desires to leftward or rightward rotate the mobile electronic apparatus 300 for 90 degree to operate the mobile electronic apparatus 300, the user can switch a displaying direction of the configurable interface of directional operation 200 by touching the interface rotation controlling area 205 of the configurable interface of directional operation 200, so that the displaying direction is switched to parallel with a direction of a view angle of the user. In such a way, whatever the user may rotate the mobile electronic apparatus 300, the configurable interface of directional operation 200 can always be adjusted to a most suitable displaying direction, along to which the user can operate the mobile electronic apparatus 300 via the configurable interface of directional operation 200 while holding the mobile electronic apparatus 300 in both of his/her hands.

Referring now to FIGS. 3A through 3C, with respect to a left handed user, he/she can touch the displaying position adjusting area 204 so as to move the configurable interface of directional operation 200 to a position adjacent to a left side border of the touch screen 110. Then, the user can adjust the displaying positions of the mouse-key area (including the right key area 201 and the left key area 202) and the cursor position controlling area 203 of the configurable interface of directional operation 200 via the common hand setting area 206 of the configurable interface of directional operation 200. After the foregoing operation, the configurable interface of directional operation 200 shown in FIG. 3A becomes as shown in FIG. 3C. FIG. 3D depicts that the user changes an operation direction of the mobile electronic apparatus 300 of FIG. 3C, in which the user can switch the displaying direction of the configurable interface of directional operation 200 by simply touching the interface rotation controlling area 205. It can be clearly seen that the left handed user can also operate the mobile electronic apparatus 300 by touching the configurable interface of directional operation 200 displayed at the position adjacent to the left border of the touch screen 110 with his/her left thumb, while holding the mobile electronic apparatus 300 in both of his/her hands, thus conveniently operating the mobile electronic apparatus.

As discussed above, it can be learnt that the displaying position and displaying direction of the configurable interface of directional operation 200 on the touch screen 110, as well as the layout arrangement of the right key area 201, the left key area 202, and the cursor position controlling area 203, can be flexibly adjusted according to habits or desirability of the user. In this concern, comparing with the conventional that includes a cursor controlling point and physical keys fixed to the screen frame, the configurable interface of directional operation 200 of the present invention provides a more convenient and more flexible approach to the user to operate the mobile electronic apparatus 300.

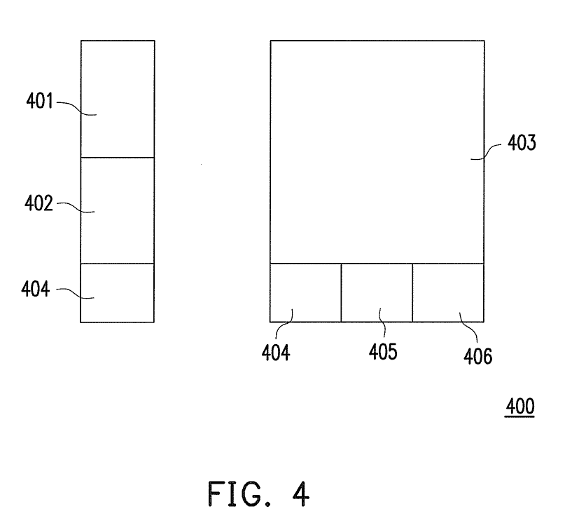

FIG. 4 is a schematic diagram illustrating a configurable interface of directional operation according to another embodiment of the present invention. Referring to FIGS. 1 and 4 together, the operation interface construction module 120 displays a configurable interface of directional operation 400 on the touch screen 110, in this embodiment. The configurable interface of directional operation 400 includes a mouse-key area (constituted by a right key area 401 and a left key area 402) and a cursor position controlling area 403. The mouse-key area and the cursor position controlling area 403 are separately displayed from each other. Specifically, a displaying position adjusting area 404 is displayed under the right key area 401 and the left key area 402 for adjusting displaying positions of the right key area 401 and the left key area 402 on the touch screen 110. Further, a displaying position adjusting area 404, an interface rotation controlling area 405, and a common hand setting area 406 are displayed under the cursor position controlling area 403. The similar elements have same or similar functions as discussed in the foregoing embodiments, and thus is not going to be iterated hereby.

Likewise, the configurable interface of directional operation 400 displayed by the operation interface construction module 120 also has a certain transparency, so as to prevent from sheltering images displayed on the touch screen 110. When the touch screen 110 does not receives any touch signal, the operation interface construction module 120 displays the configurable interface of directional operation 400 with a maximum transparency, so as to provide the user a complete viewing area.

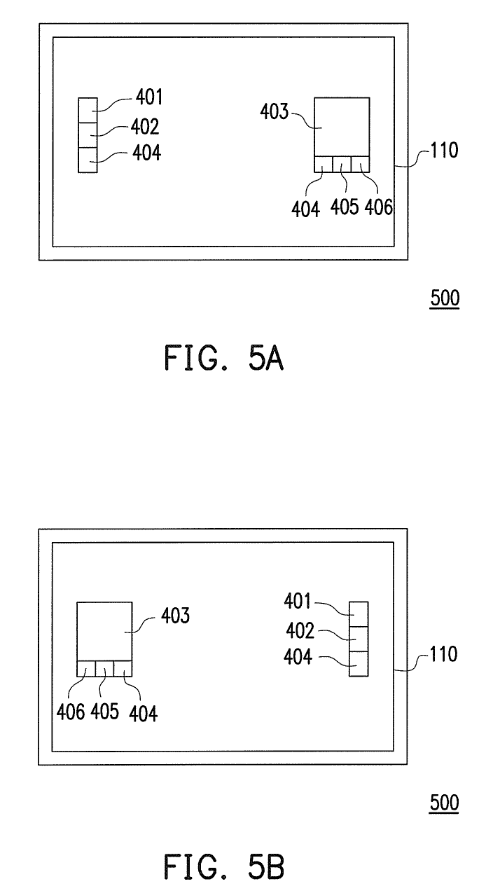

FIGS. 5A and 5B are schematic diagrams illustrating a mobile electronic apparatus 500 including a configurable apparatus for directional operation 100, according to another embodiment of the present invention. Referring to FIG. 5A, the operation interface construction module 120 (as shown in FIG. 1) displays the mouse key area and the cursor position controlling area 403 of the configurable interface of directional operation 400 at positions adjacent to the left border and the right border of the touch screen 110, respectively. As such, when the user holds the two sides (left and right) of the mobile electronic apparatus 500 with his/her both hands, respectively, he/she can conveniently use his/her thumbs to touch the right key area 401, the left key area 402, and the cursor position controlling area 403, so as to operate the mobile electronic apparatus 500. Referring to FIGS. 4 and 5B, the user can also change the displaying position and the displaying direction of the configurable interface of directional operation 400 via the displaying position adjusting area 404, the interface rotation controlling area 405, and the common hand setting area 406, as desired in accordance with the application requirement. In the current embodiment, when holding the mobile electronic apparatus 500 in both hands, the user can move the cursor and trigger the left key function or the right key function at the same time. And therefore, the present invention is adapted for maintaining an operation stability of the mobile electronic apparatus 500 for a relatively long time while remaining the portability of the mobile electronic apparatus 500.

In another embodiment of the present invention, in order to allow the user to more clearly identify functions of different areas of the configurable interface of directional operation, when displaying the configurable interface of directional operation, the operation interface construction module displays corresponding icons for reminding the user in the defined different areas, for avoiding misoperation.

Further, the configurable interface of directional operation 400 may also includes a function touch control area for combining the separately displayed mouse-key area and cursor position controlling area 403. The user can combine the separately displayed mouse-key area and cursor position controlling area 403 by touching the function touch control area, thus obtaining the configurable interface of directional operation 200 as shown in FIG. 2

It should be noted that a computer program including a plurality of program codes may be designed according to the content of the foregoing embodiments. The computer program may be built in a computer system, or stored in a computer readable storage medium (optical disk, magnetic disk, or removable hard disk, or the like). The computer program is then loaded to a mobile electronic apparatus. And then the configurable interface of directional operation can be displayed on the touch screen, so as to allow the user to operate the computer system or the mobile electronic apparatus via the configurable interface of directional operation.

In summary, the configurable apparatus for directional operation and the computer system storing the computer program for displaying the configurable interface of directional operation provided by the present invention allow the user to operate the mobile electronic apparatus via the configurable interface of directional operation displayed on the touch screen. In such a way, the present invention ascertains the user for a long time for holding and operating the mobile electronic apparatus, and also allows the user to change the appearance of the configurable interface of directional operation, so as to improve the convenience and flexibility of operating the mobile electronic apparatus.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A configurable apparatus for directional operation, comprising:
a touch screen for detecting a touch signal; and
an operation interface construction module, coupled with the touch screen, for displaying a configurable interface of directional operation on the touch screen, wherein the configurable interface of directional operation comprises a mouse-key area and a cursor position controlling area, and the operation interface construction module comprises:
a mouse-key function driving module, for triggering a mouse-key function when the touch signal is determined as positioned within the mouse-key area; and
a cursor position controlling module, for moving a cursor displayed on the touch screen according to a displacement of the touch signal in the cursor position controlling area.

2. The configurable apparatus for directional operation according to claim 1, wherein the operation interface construction module displays the configurable interface of directional operation at a position adjacent to a border of the touch screen.

3. The configurable apparatus for directional operation according to claim 1, wherein the operation interface construction module displays the mouse-key area and the cursor position controlling area at positions respectively adjacent to two individual borders of the touch screen.

4. The configurable apparatus for directional operation according to claim 1, wherein the operation interface construction module further comprises:
a displaying position adjusting module, for defining a displaying position adjusting area in the configurable interface of directional operation, and moving the configurable interface of directional operation on the touch screen according to a displacement of the touch signal when the touch signal is determined as positioned within the displaying position adjusting area.

5. The configurable apparatus for directional operation according to claim 1, wherein the operation interface construction module further comprises:
an interface rotation controlling module, for defining an interface rotation controlling area in the configurable interface of directional operation, and switching a displaying direction of the configurable interface of directional operation when the touch signal is determined as positioned within the interface rotation controlling area.

6. The configurable apparatus for directional operation according to claim 5, wherein the interface rotation controlling module switches the displaying direction to parallel with a direction of a view angle of the user.

7. The configurable apparatus for directional operation according to claim 1, wherein the operation interface construction module further comprises:
a common hand setting module, for defining a common hand setting area in the configurable interface of directional operation, and exchanging displaying positions of the mouse-key area and the cursor position controlling area when the touch signal is determined as positioned within the common hand setting area.

8. The configurable apparatus for directional operation according to claim 1, wherein the mouse-key function driving module defines a left key area and a right key area in the mouse-key area, and for triggering a mouse-key function corresponding to a left key of a mouse when the touch signal is determined as positioned within the left key area and triggering a mouse-key function corresponding to a right key of the mouse when the touch signal is determined as positioned within the right key area.

9. The configurable apparatus for directional operation according to claim 1, wherein the operation interface construction module displays the configurable interface of directional operation on the touch screen according to a transparency.

10. The configurable apparatus for directional operation according to claim 9, wherein when the touch screen does not receive any touch signal, the operation interface construction module displays the configurable interface of directional operation on the touch screen with the higher transparency.

11. A computer system, for storing a computer program comprising a plurality of program codes, the computer program being loaded in a mobile electronic apparatus having a touch screen for displaying a configurable interface of directional operation on a touch screen, the configurable interface of directional operation comprising:
a mouse-key area, for triggering a mouse-key function; and
a cursor position controlling area, for controlling a position of a cursor displayed on the touch screen.

12. The computer system according to claim 11, wherein the configurable interface of directional operation is displayed at a position adjacent to a border of the touch screen.

13. The computer system according to claim 11, wherein the mouse-key area and the cursor position controlling area are displayed at positions respectively adjacent to two individual borders of the touch screen.

14. The computer system according to claim 11, wherein the configurable interface of directional operation further comprises a displaying position adjusting area, for adjusting a displaying position of the configurable interface of directional operation on the touch screen.

15. The computer system according to claim 11, wherein the configurable interface of directional operation further comprises an interface rotation controlling area for switching a displaying direction of the configurable interface of directional operation.

16. The computer system according to claim 15, wherein the displaying direction is parallel with a direction of a view angle of the user.

17. The computer system according to claim 11, wherein the configurable interface of directional operation further comprises a common hand setting area, for exchanging displaying positions of the mouse-key area and the cursor position controlling area.

18. The computer system according to claim 11, wherein the mouse-key area further comprises a left key area and a right key area, wherein the left key area is adapted for triggering a mouse-key function corresponding to a left key of a mouse, and the right key area is adapted for triggering a mouse-key function corresponding to a right key of the mouse.

19. The computer system according to claim 11, wherein the configurable interface of directional operation is displayed on the touch screen according to a transparency.

20. The computer system according to claim 19, wherein when the touch screen does not receive any touch signal, the configurable interface of directional operation is displayed on the touch screen with the higher transparency.
